(19) United States
(12) Patent Application Publication
(10) Pub. No.: US 2016/0105209 A1
(43) Pub. Date: Apr. 14, 2016

(54) APPARATUS AND METHOD FOR SECURING OR PROTECTING ELECTRONIC DEVICES

(71) Applicants: Robert T. Dunn, New Kensington, PA (US); Bryson W. Dunn, New Kensington, PA (US); Brittany J. Dunn, New Kensington, PA (US); Brandy L. Dunn, New Kensington, PA (US); Brinley R. Dunn, New Kensington, PA (US); Brianna B. Dunn, New Kensington, PA (US); Brayley K. Dunn, New Kensington, PA (US)

(72) Inventors: Robert T. Dunn, New Kensington, PA (US); Bryson W. Dunn, New Kensington, PA (US); Brittany J. Dunn, New Kensington, PA (US); Brandy L. Dunn, New Kensington, PA (US); Brinley R. Dunn, New Kensington, PA (US); Brianna B. Dunn, New Kensington, PA (US); Brayley K. Dunn, New Kensington, PA (US)

(21) Appl. No.: 14/841,091

(22) Filed: Aug. 31, 2015

Related U.S. Application Data
(60) Provisional application No. 62/045,601, filed on Sep. 4, 2014.

(51) Int. Cl. H04B 1/3888

(52) U.S. Cl. CPC H04B 1/3888

(57) ABSTRACT

An apparatus for providing impact protection to a cell phone comprises a flexible elongated member configured to loop around an upper end of the phone, and a flexible elongated member configured to loop around a lower end of the phone, each elongated member sized to elastically stretch over and about opposing side edges of the phone. A plurality of different connecting pieces may join these two flexible members over a portion of the rear face of the phone. A method of use is also disclosed.

### CROSS-REFERENCE TO RELATED APPLICATION

This is a perfection of Provisional Application No. 62/045,601, filed on Sep. 4, 2014, the disclosure of which is fully incorporated by reference herein.

### BACKGROUND OF THE INVENTION

1. Technical Field of the Invention

This invention relates to an apparatus and method for securing and protecting electronic devices. Particularly, it relates to an apparatus that may be stretched and secured around/about the upper and lower ends/outer surfaces of electronics, such as a mobile phone, to provide it with protection and prevent damage from impact.

2. Description of the Related Art

Typically, hard compartments or cases have been utilized for transporting and preventing damage to many electronic devices. These cases are usually constructed from plastics, custom-fitted for the type of device the case is intended to hold. They serve to protect the electronic device housed within from being damaged when hit, dropped, or abused in some other way.

Alternatively, softer materials have been used to create more aesthetically pleasing covers for electronic devices such as a mobile or cell phone. These covers, some of which are made from leather or similarly “tough” fabrics prevent the device from being scratched during regular wear and tear.

Although hard plastic cases may be suitable for storing electronic devices, they are bulky and may make it more difficult to carry on one's person such as in a shirt pocket. These cases are also more expensive than lighter materials such as the soft covers already discussed.

Conversely, the lighter, less expensive leather covers are not protective enough. While suitably flexible for fitting around a cell phone, leather covers do not provide adequate protection from certain types of common stress like when these phones get dropped or otherwise incur unexpected impacts.

Therefore, there is a need for a device that is inexpensive, flexible, lightweight, and easily transportable, yet constructed of a sufficiently strong material to provide adequate protection for phones and other electronic devices. It is to these ends that the present invention has been developed.

### SUMMARY OF THE INVENTION

To minimize the limitations of the prior art, the present invention provides an apparatus and method for securing and protecting electronic devices from impact. Per the preferred embodiments described below, the apparatus comprises a pair of ring-like bodies that loop around the upper and lower ends of an electronic device to form a sufficiently protective cushion to the most vulnerable sides/ends of that device.

A method for protecting devices using the aforementioned apparatus comprises: selecting a pair of loop rings for said electronic device; and then wrapping the upper and lower ends/edges of same with the selected loop ring pairs.

Another apparatus for absorbing the impact of a dropped electronic device comprises a main pair of upper and lower body loops joined together with one of several upper/lower edge protectors and/or one of several varieties of loop connectors for extending along a rear face of the electronic device (such as the back of the cell phone proper).

It is an objective of the present invention to provide an apparatus that is flexible enough to conform to a variety of electronic devices.

It is another objective of the present invention to provide an apparatus that is strong enough to withstand significant impact, providing electronics such as mobile phones with adequate protection from common user-inflicted stresses.

It is still another objective of the present invention to provide electronic devices with a protective material that is strong, yet lightweight, so as to allow easy transportation.

It is another objective to provide electronic devices with protective loops that can be custom selected for color coordination with school colors and/or favorite sports teams.

It is still another objective of the present invention to provide an apparatus that may be easily attached.

It is still another objective of the present invention to provide an apparatus made of a material that can absorb shock and produce a bounce when dropped. For these reasons, one proposed marketing name for this invention is iShock™.

These and other advantages and features of the present invention are described with specificity so as to make the present invention understandable to one of ordinary skill in the art.

### BRIEF DESCRIPTION OF DRAWINGS/PHOTOGRAPHS

Elements in the accompanying figures have not necessarily been drawn to scale to enhance their clarity and improve understanding of these various elements and embodiments of the invention. The drawings and several color photographs are generalized in form in the interest of clarity and conciseness.

FIG. 1 is a top plan view of the front to a cell phone with a pair of differently colored protective loops around the upper and lower ends per one embodiment of the invention;

FIG. 2 is a top plan view of the rear to the cell phone of FIG. 1;

FIG. 3 is a top plan view of a cell phone rear view showing a first alternative embodiment with criss-crossing bands between the two main (upper and lower) loops;

FIG. 4 is a top plan view of the front to a second alternative embodiment showing a pair of upper and pair of lower edge bumpers added to the respective upper and lower band/loops;

FIG. 5 is a top plan view showing the rear view to the second alternative embodiment in FIG. 4;

FIG. 6 is a top plan view of the rear to a third alternative embodiment showing a single vertical connector band between upper and lower band/loops;

FIG. 7 is a top plan view of the rear to a fourth alternative embodiment showing two vertical connector bands between upper and lower band/loops;

FIG. 8 is a top plan view of the rear to a fifth alternative embodiment that is a combination of the connectors from FIGS. 3 and 6;

FIG. 9 is a top plan view of the rear to a sixth alternative embodiment showing two pairs of X-shaped connector bands between upper and lower band/loops;

FIG. 10 is a top plan view of the rear to a seventh alternative embodiment showing two semi-circular connectors between the pair of upper and lower band/loops, said two connectors being further joined with a pair of vertically extending strap/bands;

FIG. 11 is a top plan view of the rear to an eighth alternative embodiment showing a plurality (at least three) of horizontally extending X-shaped cross bands that form a netting-like holder on the rear of the cell phone;

FIG. 12 is a top plan view of the rear to a ninth alternative embodiment showing at least three vertical connector bands between the pair of upper and lower band/loops;

FIG. 13 is a top plan view of the rear to a tenth alternative embodiment, similar to that of FIG. 10 but with a circular loop connector between the semi-circular connectors from the upper and lower band/loops;

FIG. 14 is a top plan view of the rear to an eleventh alternative embodiment showing the extension of a cross-web netting (running both horizontally and vertically) between the pair of upper and lower band/loops;

FIG. 15 is a top plan view of the rear to a twelfth alternative embodiment showing a zippered compartment extending between the pair of upper and lower band/loops;

FIG. 16 is a side view showing a windshield hook unit for use with a banded cell phone according to one embodiment of accessory item per the present invention;

FIG. 17 is a side view showing a vehicle dashboard hook mount variation for use with a banded cell phone;

FIG. 18 is a side view showing a vehicle vent clip mount alternative for use with a banded cell phone; and

FIG. 19 is a perspective view showing a computer monitor clip for use with a banded cell phone (not shown).

### DESCRIPTION OF PREFERRED EMBODIMENTS

In the following discussion that addresses a number of embodiments and applications of the present invention, reference is made to the accompanying drawings and photographs that form a part hereof, and in which are shown by way of illustration specific embodiments in which the invention may be practiced. It is to be understood that still other embodiments may be utilized and changes may be made without departing from the scope of the invention.

In these accompanying views, the electronic device is shown as a representative cell phone. It is to be understood, however, that the device could also be an mp3 or other musical player, an electronic reader (Nook® or Kindle® device), a tablet computer (such as an Ipad or its equivalent), or most any other rectangular apparatus. All such devices, generally 10, share a front face 12, rear face 14, top edge 16, bottom edge 18 and side edges 20, 22. Usually, the front face 12 includes a power button 24 on its lower bar 26 beneath front viewing/touch screen 28, a camera portal 30 and a microphone portal 32. The rear face 14 includes a camera with more sophisticated, elaborate lens 34. Sometimes, a rear speaker and/or lighted product logo 36 adorns the hard back cover to rear face 14. These components are consistently numbered in the alternate views of this invention (FIGS. 1 through 15).

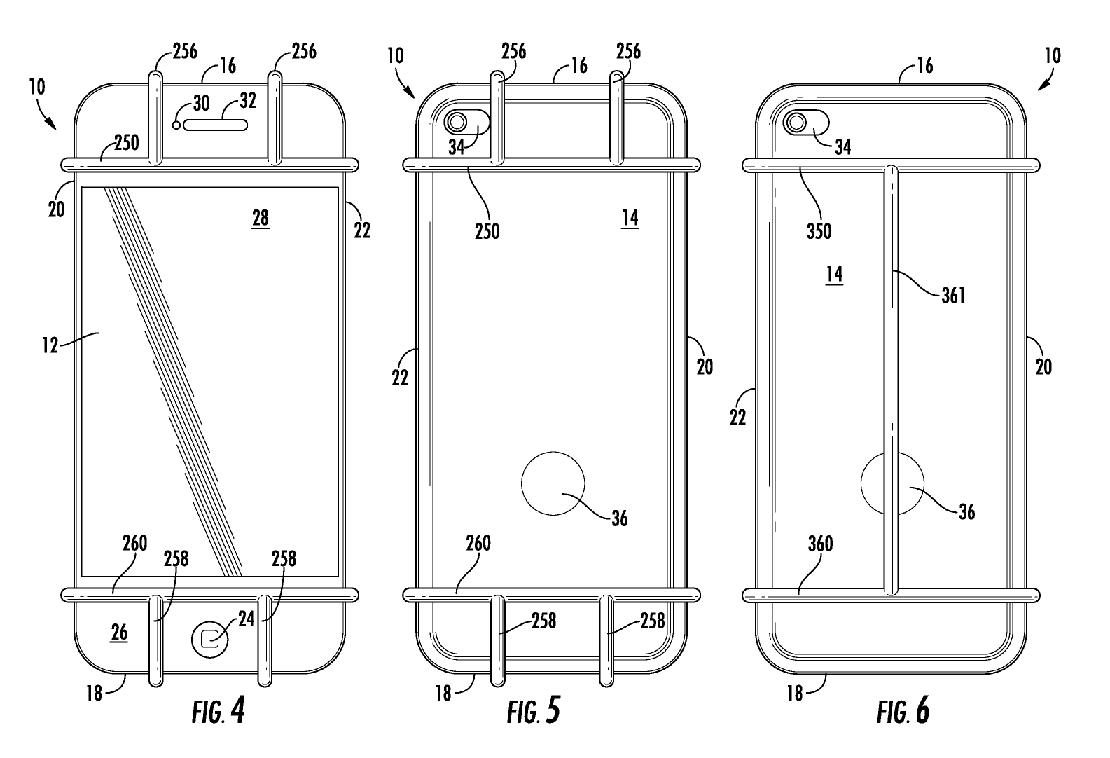

As for the various component parts to the protective band/loops in these same views, they are also commonly numbered between the various alternative embodiments, though in the next hundred series. For example, top band 50 in FIGS. and 2 has an equivalent top band 150 in FIG. 3, 250 in FIGS. 4 and 5, and 350 in FIG. 6, etc.

Typically, the two main loop protectors for cell phones and other electronic devices, top band 50 and bottom band 60 are both flexible, constructed of rubber, neoprene or plastic providing them (the loops) with a wide range of motion for easy attachment to the upper and lower side edges 20, 22 of the electronic device (or representative cell phone 10). Using these materials, the protector bands (a.k.a. “iShock” straps) will allow the phones/e-devices to sustain a varying range of stress. Band/loops 50, 60 are intentionally lightweight, flexible, strong and yet quite shock absorbent. They are capable of stretching around and about a variety of devices so that they may protect different brands, models and types of phones, portable CD or DVD player, radio, mp3 player (or iPod®), portable digital camera, even some lighter weight tablets. Once properly secured and situated, these band pairs will allow the device to withstand most slight bounces when dropped due to the rubber-like material banding their most vulnerable edge regions.

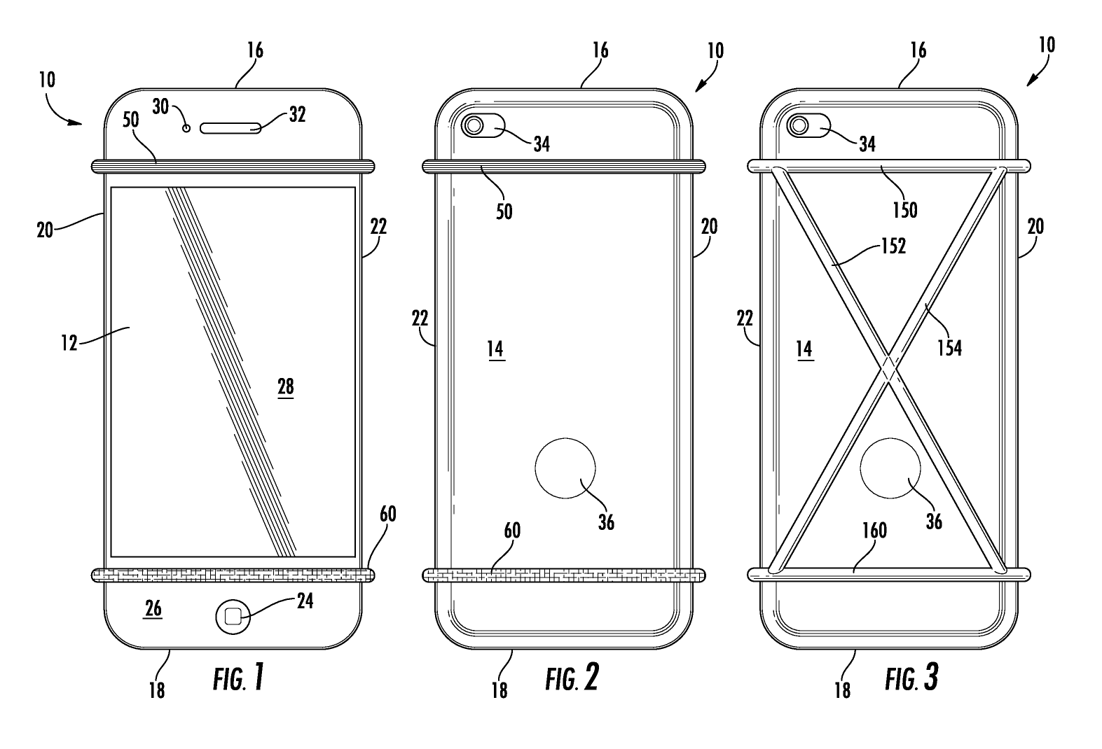

Main loops 50 and 60 could both be colored from the same material, black bands, for instance. But in accompanying FIGS. 1 and 2, they are shown depicted in separate, distinct colors, a top lined for a blue coloring and the bottom in yellow to better illustrate how these electronic protectors can be made AND SOLD in a variety of colors for coordinating with outfits, sports team allegiances and/or school colors.

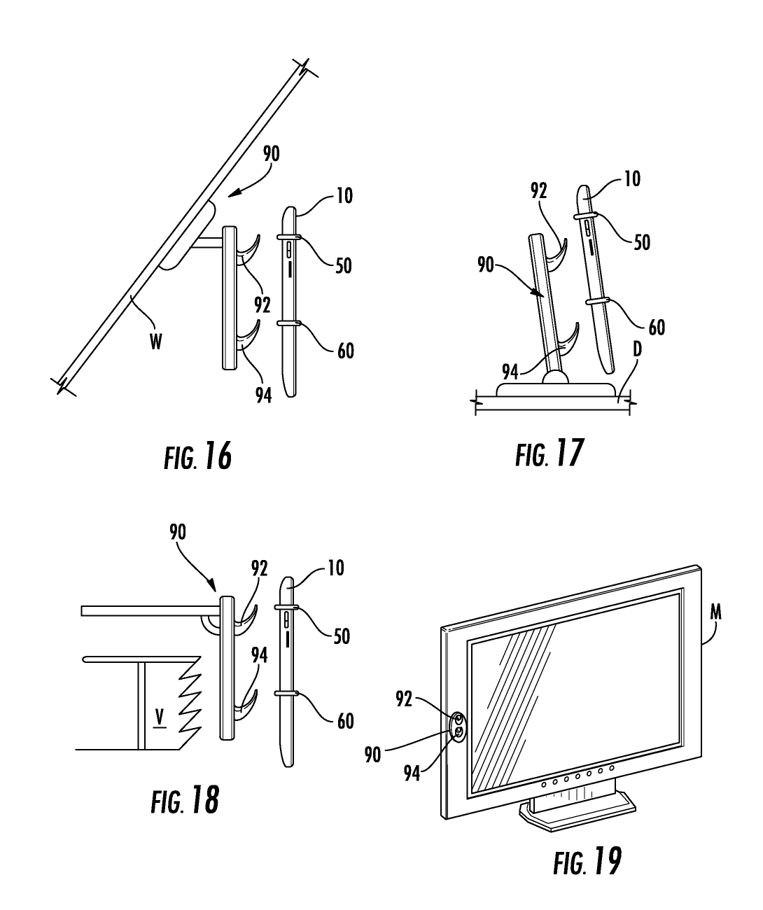

Main loops 50 and 60 may further comprise additional cross bands, generally 70, along the rear face 14 of device 10 so as to not interfere with its day-to-day usage. They will not distract the phone user. On the contrary, additional cross bands 70 can serve as finger holds and/or areas for clipping a phone/device for hands free use. The latter clips are best seen in several representative embodiments in the drawings at FIGS. 16 through 19. Particularly, FIG. 16 shows a vehicular windshield W with its own glass mounted clip 90 having a pair of vertically situated hooks 92, 94. That same dual hook configuration is part of a vehicle dashboard D mounting in accompanying FIG. 17. FIG. 18 shows a third vehicular variation that would allow for the dual hook arrangement 90 into and possibly, at least partially about, one or more louvers to the vehicle's air ventilation duct V. Finally, FIG. 19 shows a stick-on variation of dual hook arrangement 90 for the side bar/surround of a computer monitor (or television screen) M.

In the first main alternative of FIG. 3, The two main band/loops 150, 160 are joined across the rear face 14 of device 10 with a pair of cross-crossing band connectors, a first connector 152 that extends diagonally from the left side of upper band/loop 150 to the lower right side of lower band loop 160. A second connector 154 extends across the opposite corners to form an X-pattern over the main part of rear face 14.

In the second main alternative, at FIGS. 4 and 5, the potentially vulnerable upper 16 and lower 18 edges to device 10 are further protected with a pair of upper edge bumpers 256 extending between front 12 and rear 14 faces of device 10 from both upper sides of top band 250, with a corresponding set of lower edge bumpers 258 connecting about both front and rear sides of lower band 260 in an unobtrusive location. These edge bumpers would be made from the same material and can be commonly colored or provided in complementary, alternative color schemes.

In still other alternate embodiments, both upper and lower main loops are joined to one another along just the rear face of a cell phone (or other e-device) with additional bands made from the same material. There are numerous ways to cross-connect these two main bands. The variations depicted in accompanying FIGS. 6 through 15 are merely representative.

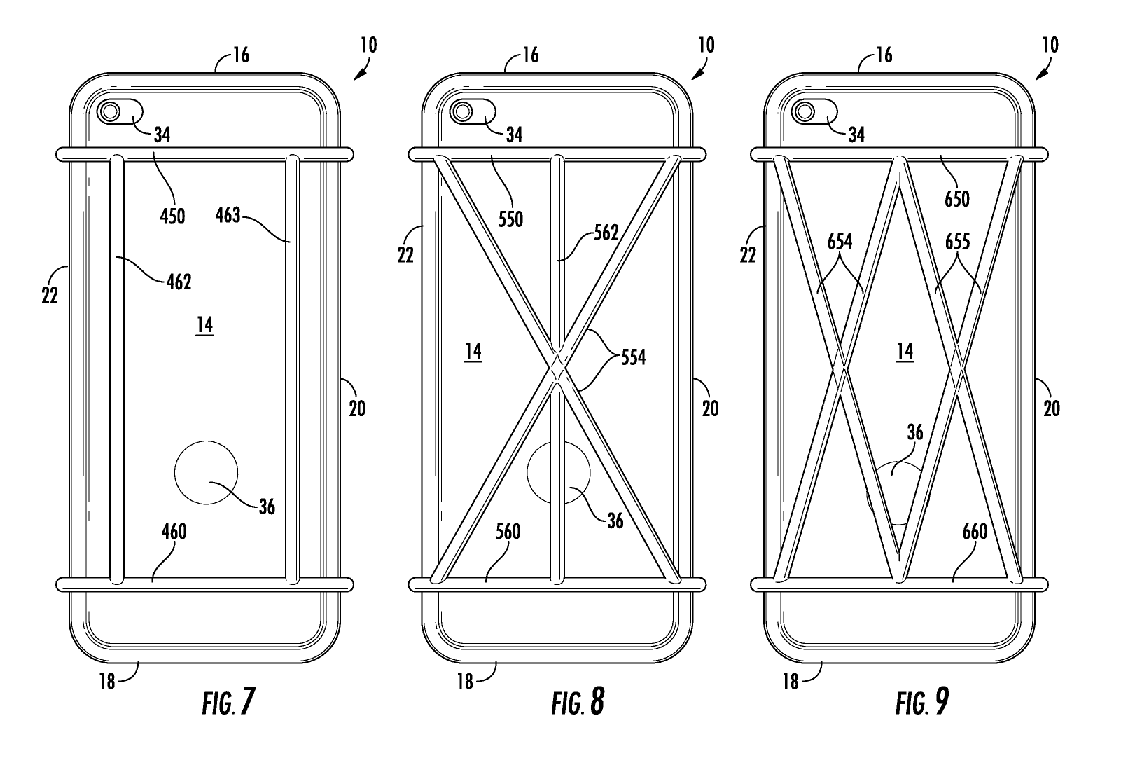

FIG. 6 has a single vertical band line 361 extending between upper horizontal band 350 and lower horizontal band 360. FIG. 7 adds to its two horizontal bands 450, 460, a second vertical band 463 to its first vertical band 462 closer to the side edges 20, 22 of device 10. Then, in a fifth alternative embodiment at FIG. 8, there is a combination of both FIGS. 3 and 6, with a criss-cross X band 554 AND single vertical band 562 between upper band 550 and lower band 560.

Still other connections may be added between main loops X50 and X60. Particularly, FIG. 9 adds a pair of side-by-side X bands 654, 655 between its upper band 650 and lower band 660.

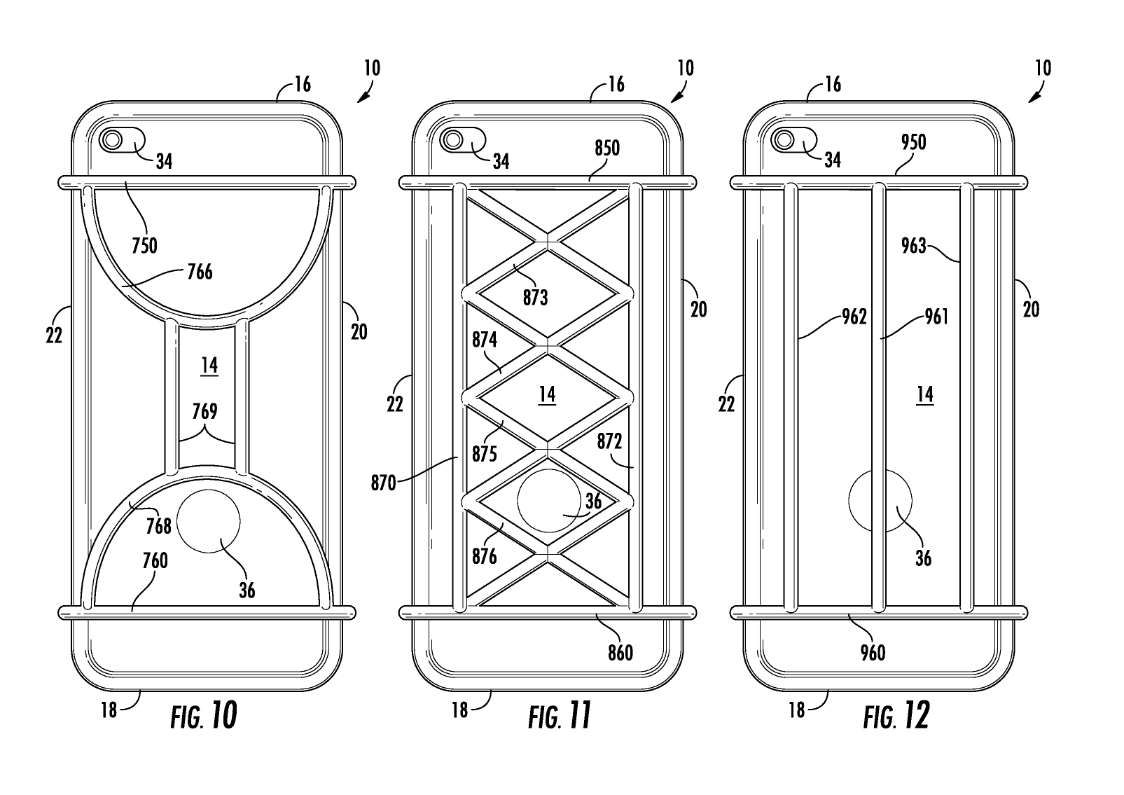

The device 10 at FIG. 10 has a pair of semi-circular loops 766, 768 from main bands 750, 760 with further connection provided by shortened vertical connectors 769. Two such connectors are shown but one, and three or more may be used as well.

Depending on the number and shape of these cross-bands, they can form an elastic type holder for business cards, work ID's, etc. In FIG. 9, that card-holder compartment was formed from the pair of X-shaped cross bands 654, 655. FIG. 11 rotates such X-shaped connectors ninety degrees to provide a netting-like backing for business cards, paper currency and/or other nominal storage. Particularly, a pair of vertically-extending connector bands 870, 872 between main bands 850, 860 are further interconnected with several shorter X-band connectors 873, 874, 875 and 876. Four are shown as representative. Still other variations may include two, three, five or six X-bands between verticals 870, 872.

In FIG. 12, there is another variation that is a combination of earlier FIGS. 6 and 7. Particularly, between its two main bands 950, 960, there is a centermost vertical connector 961 flanked on both sides with additional vertical connectors 962 and 963.

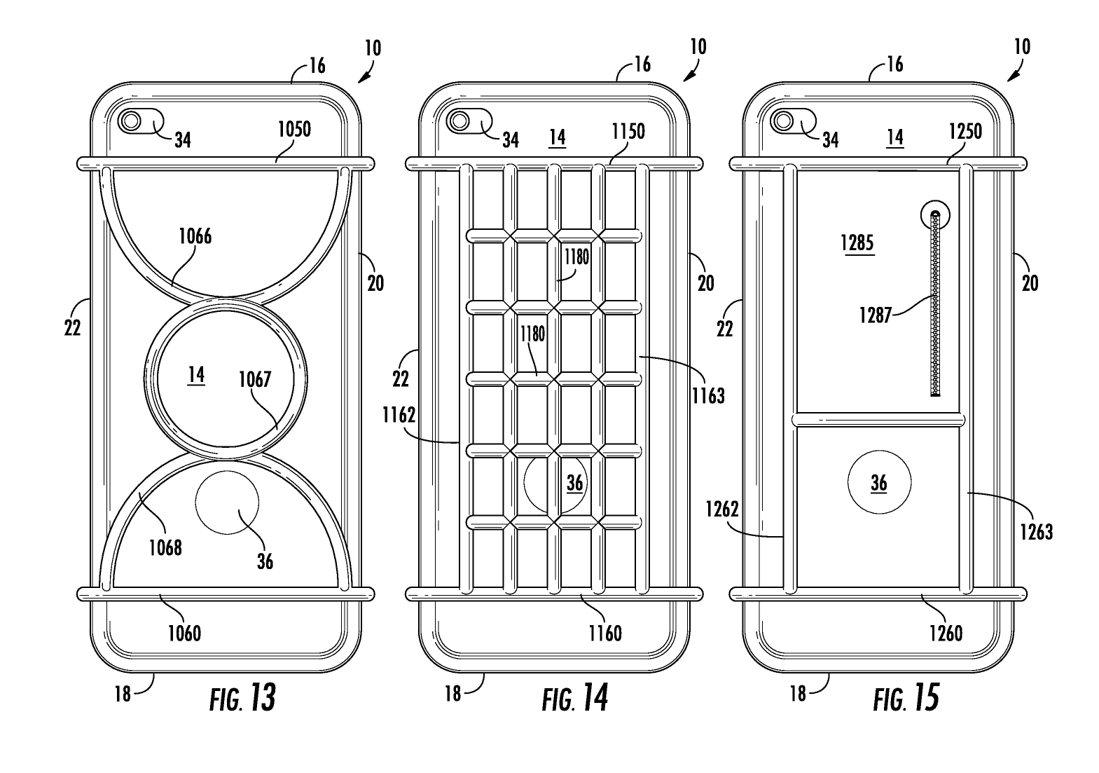

FIG. 13 represents another variation using the two semi-circular shaped connectors of FIG. 10, elements 1066 and 1068 (between main bands 1050 and 1060) with a circular-shaped connector 1067 joining the two semi-circles to one another.

FIG. 14 reverts to a web of vertically and horizontally extending cross-connector bands, collectively 1180, between vertical band extensions 1162, 1163 that further connect main upper band 1150 to main lower band 1160.

Finally, in a totally distinct variation, FIG. 15 shows a pocket 1285, with its own zipper 1287 situated between upper and lower loops 1250, 1260 and adjoining side loops 1262, 1263.

Both an apparatus and method for securing/protecting electronic devices from impact have been described. The foregoing description of the various exemplary embodiments of the invention is presented for purposes of illustration and disclosure. They are not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. An impact-protected electronic apparatus, comprising: an electronic device; and a protective member comprising a pair of flexible elongated members configured to elastically stretch over and about both side edges of said electronic device at an upper end and a lower end of the electronic device.

2. The apparatus of claim 1 wherein each flexible elongated member is made from rubber, neoprene, plastic or a combination thereof.

3. The apparatus of claim 1 wherein the electronic device is a cell phone.

4. The apparatus of claim 1 wherein each flexible elongated member includes a rubber O-ring component.

5. The apparatus of claim 1 wherein a first flexible elongated member consists of a first colored band and a second flexible elongated member consists of a second colored band different from the first colored band.

6. The apparatus of claim 1 wherein the flexible elongated member at the upper end of the electronic device connects to itself with one or more edge bumpers extending over a top edge of the electronic device, and
the flexible elongated member at the lower end of the electronic device connects to itself with one or more edge bumpers extending over a bottom edge of the electronic device.

7. The apparatus of claim 6 where each flexible elongated member has two perpendicular extending edge bumpers.

8. The apparatus of claim 1 wherein the flexible elongated member at the upper end of the electronic device and the flexible elongated member at the lower end of the electronic device connect to each other with a connector that extends across a portion of the rear face of the electronic device.

9. The apparatus of claim 8 wherein the connector includes one or more criss-crossing members connecting to both the flexible elongated member at the upper end of the electronic device and the flexible elongated member at the lower end of the electronic device.

10. The apparatus of claim 8 wherein the connector includes one or more vertically extending members that connect perpendicularly to both the flexible elongated member at the upper end of the electronic device and the flexible elongated member at the lower end of the electronic device.

11. The apparatus of claim 10 wherein the connector further includes one or more criss-crossing members that connect to both vertically extending members extending between the flexible elongated member at the upper end of the electronic device and the flexible elongated member at the lower end of the electronic device.

12. The apparatus of claim 8 wherein the connector includes a semi-circular extension downwardly from the flexible elongated member at the upper end of the electronic device and a semi-circular extension upwardly from the flexible elongated member at the lower end of the electronic device with both semi-circular extensions joined to one another with a connector that includes: one or more vertically extending connectors, a circular joining connection or combinations thereof.

13. The apparatus of claim 8 wherein the connector includes a plurality of vertical and horizontal extensions that form a flexible net over the rear face of the electronic device.

14. The apparatus of claim 8 wherein the connector includes a security pocket connected to vertical extensions between the flexible elongated member at the upper end of the electronic device and the flexible elongated member at the lower end of the electronic device.

15. An apparatus for providing impact protection to a cell phone, said apparatus comprising a flexible elongated member configured to loop around an upper end of the cell phone, and a flexible elongated member configured to loop around a lower end of the cell phone, each elongated member sized to elastically stretch over and about opposing side edges of the cell phone.

16. The apparatus of claim 15 wherein the flexible elongated member at the upper end of the cell phone connects to itself with one or more edge bumpers extending over a top edge of the cell phone, and
the flexible elongated member at the lower end of the cell phone connects to itself with one or more edge bumpers extending over a bottom edge of the cell phone.

17. The apparatus of claim 15 wherein the flexible elongated member at the upper end of the cell phone and the flexible elongated member at the lower end of the cell phone connect to each other with a connector that extends across a portion of the rear face of the cell phone.

18. The apparatus of claim 17 wherein the connector includes one or more criss-crossing members connecting to both the flexible elongated member at the upper end of the cell phone and the flexible elongated member at the lower end of the cell phone.

19. The apparatus of claim 17 wherein the connector includes one or more vertically extending members that connect perpendicularly to both the flexible elongated member at the upper end of the cell phone and the flexible elongated member at the lower end of the cell phone.

20. A method for providing impact protection to a cell phone, said method comprising:
selecting a pair of flexible elongated members configured to loop around upper and lower ends of the cell phone with each elongated member sized to elastically stretch over and about lateral edges of said cell phone; and
looping the flexible elongated members selected about the upper and lower ends of the cell phone.
